(19) United States
(12) Patent Application Publication
(10) Pub. No.: US 2007/0215263 A1
(43) Pub. Date: Sep. 20, 2007

(54) Print Cartridge System for Multi-Jurisdictional Tax Stamping

(76) Inventors: Kerry Quinn, Palatine, IL (US); Adam Sloma, Arlington Heights, IL (US); John Levander, South Elgin, IL (US)

Correspondence Address: CARDINAL LAW GROUP, Suite 2000, 1603 Orrington Avenue, Evanston, IL, 60201, US

(21) Appl. No.: 11/685,556

(22) Filed: Mar. 13, 2007

Related U.S. Application Data
(60) Provisional application No. 60/782,006, filed on Mar. 14, 2006.

(51) Int. Cl. B32B 37/00; B32B 37/12; B32B 38/06

(52) U.S. Cl. 156/64; 156/538; 156/539; 156/378; 156/362; 156/60; 156/556

(57) ABSTRACT

A system for applying a stamp to packs within a carton includes a conveyor system and a stamping system positioned along the conveyor system. The stamping system includes a stamp cartridge and a stamp applicator positioned adjacent the stamp cartridge. The cartridge dispenses stamps and the applicator applies the dispensed stamps to the packs. A method for applying a stamp to packs within a carton includes advancing at least one carton having a plurality of packs to a stamping station, dispensing stamps from a stamp cartridge positioned at the stamping station, and applying the dispensed stamps to the packs.

### RELATED APPLICATIONS

This application claims the benefit of U.S. Provisional Patent Application 60/782,006 filed Mar. 14, 2006, the entirety of which is incorporated herein by reference.

### TECHNICAL FIELD OF THE INVENTION

The present invention relates generally to stamping equipment, and in particular stamping cigarette tax stamps onto packs of cigarettes.

### BACKGROUND OF THE INVENTION

Many jurisdictions tax the sale of cigarettes. Cigarettes are most typically distributed in boxes, each box including 30 cartons of cigarettes, and each carton containing 10 packs of cigarettes, and each pack includes 20 cigarettes. There is no industry standard for the size of cigarettes or cartons. Therefore, cartons of cigarettes are distributed in a variety of heights and widths, depending on the brand and the dimensions of cigarettes for that brand. The packs are disposed inside each one of the cartons within an array comprising two rows of packs with each row of packs comprising five packs. In other words, the cigarette packs are disposed within an array comprising two rows and five columns.

Generally, payment of the tax is evidenced by application of a stamp to each pack of cigarettes prior to distribution to a retailer. However, cigarette manufacturers often do not know the retail destination of each carton, and therefore distribute un-stamped cartons to distributors, and the distributors apply the tax stamps. Typically, tax stamps are applied to a bottom surface of the pack. Generally speaking, then, the bottom surface of the pack, i.e. opposite the intended distribution hole for the cigarettes, is the upper surface of the pack when discussing stamping operations.

Distributors must, thus, open each carton of cigarettes, apply the correct tax stamp to each pack, and close the carton after application of the tax stamp. While these tasks can be performed manually, mechanical assistance is generally used in order to increase throughput.

One of the most sensitive aspects of applying the stamps to the packs is the actual application of the stamp to the pack. Currently, tax stamps are sold to distributors for application to packs on backing paper, typically for a hot stamp application. Other tax stamps are adhesive based. Typically, the backing paper includes tractor-feed peg holes in the sides of the carrier paper to interface with a tractor drive mechanism.

Typically an individual stamping application facility serves retail customers in multiple tax jurisdictions with each jurisdiction requiring a different jurisdictional stamp. In these situations it is common practice to apply only a portion of the total number of stamps on a particular roll at one time. These so called ‘partial rolls’ are then removed and replaced with a new full or partial roll from a different jurisdiction

The backing paper can be susceptible to tearing, especially in high changeover environments as rolls of stamps are placed on the stamping machine and taken off the machine. Additionally, the changeover between rolls can result in an operator's hands being in close proximity to the hot iron. Such close proximity can lead to thermal discomfort for the operator, as well as result in additional undesirable consequences.

Furthermore, as the amount of taxes assessed in each jurisdiction increases, the value of an inventory of tax stamps increases. Such value can render the tax stamp inventory subject to shrinkage or loss. Additionally, even slight tears in the tractor feed holes can undesirably displace the stamps relative to the packs so that only a portion of the stamp is disposed on the packs. Such a situation can result in extensive penalties assessed against the retailer and/or distributor and is highly undesirable.

Additionally, changing rolls of stamps can be time consuming. Each changeover can take several minutes, and several changeovers can be required per hour in a high volume environment. Such time undesirably increases the cost of applying the stamps to the packs.

As each jurisdiction increases cigarette taxes, distributors are attempting to reduce the length of time between application of a tax stamp and distribution to a retailer based on an order. Such attempts are targeted at reducing overhead costs. Many distributors find it advantageous to apply tax stamps in relatively short runs, such as in response to an order. Thus, rather than maintain an inventory of stamped cigarettes, such distributors desire to apply the tax stamps only immediately prior to distribution to a retail customer.

Therefore, it would be desirable to provide a system for applying a stamp to packs that would overcome the aforementioned and other disadvantages.

### SUMMARY OF THE INVENTION

One aspect of the invention provides a system for applying a stamp to packs within a carton includes a conveyor system and a stamping system positioned along the conveyor system. The stamping system includes a stamp cartridge and a stamp applicator positioned adjacent the stamp cartridge. The cartridge dispenses stamps and the applicator applies the dispensed stamps to the packs.

Another aspect of the invention provides a method for applying a stamp to packs within a carton that includes advancing at least one carton having a plurality of packs to a stamping station, dispensing stamps from a stamp cartridge positioned at the stamping station, and applying the dispensed stamps to the packs.

An additional aspect of the invention provides a system for applying a stamp to packs within a carton. The system includes means for advancing at least one carton having a plurality of packs to a stamping station, means for dispensing stamps from a stamp cartridge positioned at the stamping station, and means for applying the dispensed stamps to the packs.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

### BRIEF DESCRIPTION OF THE DRAWINGS

FIG. 1 illustrates one embodiment of a system for applying a stamp to packs within a carton in accordance with one embodiment of the present invention;

FIG. 2A illustrates a stamp cartridge, in accordance with one embodiment of the present invention;

FIG. 2B illustrates a stamp cartridge, in accordance with one embodiment of the present invention;

FIG. 2C illustrates a stamp cartridge, in accordance with one embodiment of the present invention;

FIG. 3 is a flowchart illustrating one example of a method for applying a stamp to packs within a carton, in accordance with another aspect of the invention;

FIG. 4 is a flowchart illustrating one example of a method for applying a stamp to packs within a carton, in accordance with another aspect of the invention;

FIG. 5 is a flowchart illustrating one example of a method for applying a stamp to packs within a carton, in accordance with another aspect of the invention; and

FIG. 6 is a flowchart illustrating another method for applying a stamp to packs within a carton, in accordance with another aspect of the invention.

### DETAILED DESCRIPTION OF THE PRESENTLY PREFERRED EMBODIMENTS

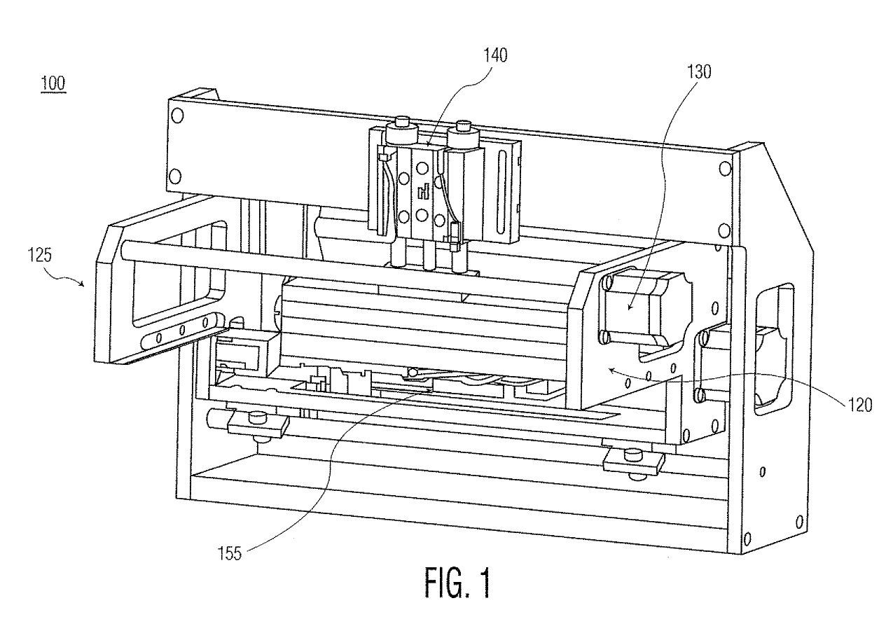

FIG. 1 illustrates one embodiment of a system for applying a stamp to packs within a carton in accordance with one embodiment of the present invention. System 100 includes a frame 110, a first cartridge sidewall 120 and a second cartridge sidewall 125 opposite the first cartridge sidewall 120. First and second cartridge sidewalls 120, 125 define the lateral sides of a cartridge space. At least one motor 120 is positioned along at least one of first and second cartridge sidewalls, and configured to operably drive a dispensing device within a stamp cartridge. Motor 120 can be driven by any appropriate power source (not shown).

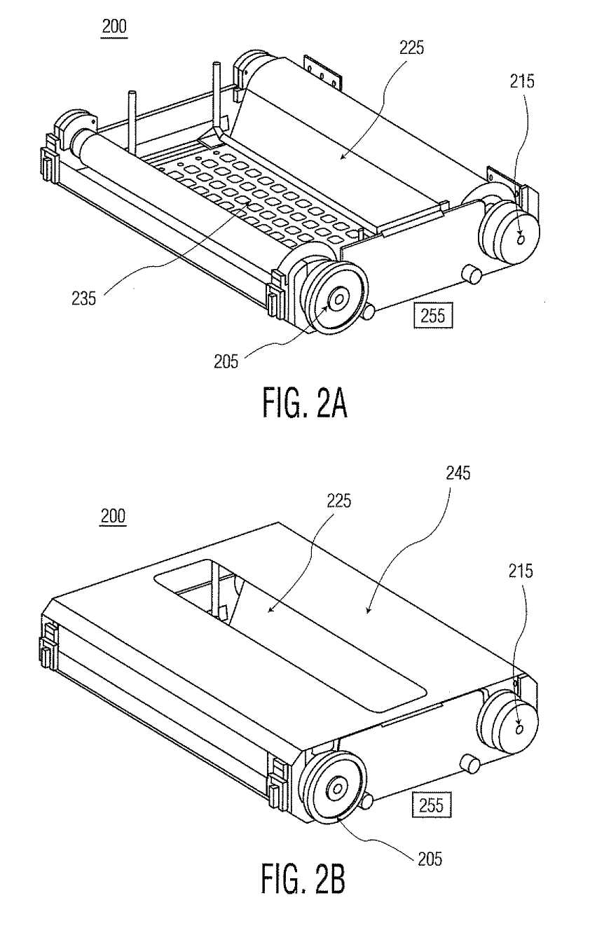

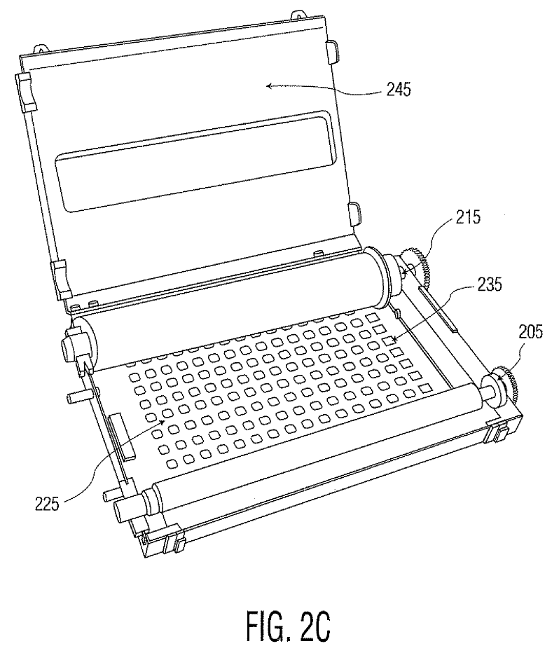

A stamp applicator 140 is further attached to frame 110. For example, the stamp applicator can be a hot iron. The stamp applicator is configured to apply stamps dispensed by the stamp cartridge (see FIGS. 2A and 2B). Cartridge confirmation receiver 155 attaches to frame 110 and interfaces with cartridge confirmation device 255 (FIGS. 2A and 2B).

FIGS. 2A and 2B illustrate an embodiment of a stamp cartridge in accordance with the invention at 200. FIG. 2A illustrates the stamp cartridge in an open configuration, suitable for loading or unloading the stamp cartridge. Conversely, FIG. 2B illustrates the stamp cartridge in a closed configuration, suitable for insertion into a stamping device for application of stamps.

FIG. 2A illustrates a gear driven mechanism for translating a roll of stamps. Stamp cartridge 200 includes a take up roller 205 and stamp payout roll 215. Backing paper 225 extends between take up roller 205 and stamp payout roll 215. Backing paper 225 includes a plurality of stamps 235 disposed upon the surface of backing paper 225. Take up roller 205 and stamp payout roll 215 cooperate to place a new set of stamps 235 in an operable position for placement on a pack. Upon application of a stamp, such as with a hot iron, take up roller 205 and stamp payout roll 215 cooperate to move a new stamp into position, while take up roller 205 winds the spent backing paper. In one embodiment, the paper roll is driven only by application of torque to the take up roller 205 and stamp payout roll 215 cores

In one embodiment, stamp cartridge 200 includes a tractor feed device, such as tractor rolls. In another embodiment, stamp cartridge 200 includes rollers configured to exert a force against more than a negligible portion of the width of the backing paper 225. In one embodiment, the rollers are configured to exert force against a portion of the backing paper 225 that does not include stamps, or a portion of the paper from which the stamps have been previously removed via application to a pack.

FIG. 2B illustrates the cartridge 200 with lid 245 covering the interior of the cartridge. Take up roller 205 and stamp payout roll 215 are visible, as in FIG. 2A. The lid 245 can be freely removable, or include a latch to keep the lid in position. Additionally, the lid 245 can be configured to require a special tool for removal. Alternatively, lid 245 can be configured with a lock, or other similar security feature. Lid 245 is configured to translate between an open position (such as in FIG. 2A) and a closed position (such as seen in FIG. 2B).

Additionally, in one embodiment, cartridge 200 includes a cartridge confirmation device 255. Cartridge confirmation device 255 interfaces with cartridge confirmation receiver 155, and collectively the cartridge confirmation device 255 and cartridge confirmation receiver 155 can be referred to as the cartridge confirmation system.

Cartridge confirmation device 255 includes data indicative of special information unique to the stamps or stamp rolls such as stamp jurisdiction, stamp serial numbers, stamp roll numbers etc. For example, the data can be stored on a memory device, such as a chip. Additionally, the data can be stored on a RFID chip. In addition to the memory device, cartridge confirmation device 255 includes equipment to communicate the data to the cartridge confirmation receiver. The communication device can be a network connection, either wired or unwired, or a RFID device.

Cartridge confirmation device 255 includes a controller configured to compare received jurisdiction data from cartridge confirmation device 255 with a carton order input to confirm, such as with a sensor, that the stamps to be applied are appropriate in view of the carton order being processed.

In one embodiment, the cartridge confirmation system includes a stamp counter configured to modify a count based on application of a stamp. Modification of a count can include incrementing, or decrementing the stamp counter based on the application of a stamp. The stamp counter can be used to track the number of stamps remaining in a cartridge, or to track the number of cartons remaining to be stamped in order to fulfill an order based on the order input.

In another embodiment, cartridge 200 includes a sensing device configured to sense a location of at least one stamp. The sensing device is in communication with a positioning controller configured to adjust the position of the backing paper, such as by winding or unwinding the backing paper 225, to advance the stamp to a predetermined position. In one embodiment, the sensing device includes a light receptor configured to determine the location of tractor feed holes or other similar markings disposed on a side of the backing paper 225. By moving the backing paper 225, the positioning controller translates the stamps.

FIG. 2C illustrates another embodiment of the stamp cartridge. Shown in FIG. 2C, are backing paper 225, stamps 235, lid 245, take up roller 205 and stamp payout roll 215. Lid 245 is illustrated in an open configuration, exposing the take up roller 205 and stamp payout roll 215, enabling changeover of each of the rolls.

In an exemplary embodiment, the stamp cartridge system disclosed herein can be employed in a linear stamp application machine, such as the machines disclosed in United States Patent Application Publication 2004/0084130 to Michalski, the entirety of which is incorporated herein. In another exemplary embodiment, the stamp cartridge system disclosed herein can be employed in a linear stamp application machine such as the machine disclosed in U.S. patent application Ser. No. ______ (atty docket 20110 1231/10) to Quinn, the entirety of which is incorporated herein. In another exemplary embodiment, the stamp cartridge system disclosed herein can be employed in a rotary stamp application machine such as the machine disclosed in U.S. patent application Ser. No. ______ (atty docket 20108 1231/8) to Quinn, the entirety of which is incorporated herein.

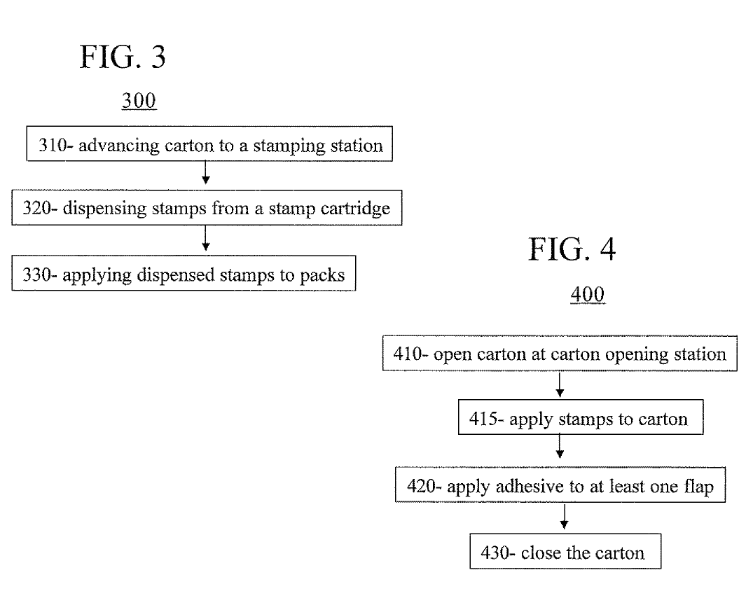

FIG. 3 illustrates a flowchart illustrative of a method 300 for applying a stamp to packs within a carton, in accordance with another aspect of the invention.

Method 300 begins at 310 by advancing a carton to a stamping station. The carton includes a plurality of packs. The carton can be advanced manually, or with mechanical assistance, such as with a conveyor.

At step 320, stamps are dispensed from a stamp cartridge positioned at the stamping station. The stamps can be dispensed by feeding the stamps, such as with a roller or tractor. For example, the stamps can be attached to a paper backer for application with a hot iron.

At step 330, the dispensed stamps are applied to the packs within the carton. For example, the stamps can be applied with a hot iron. In other examples, the stamps can be applied with adhesives.

FIG. 4 illustrates a flowchart illustrative of a method 400 for applying stamps to packs within a carton. Method 400 begins by opening the carton at a carton opening station at step 410. Opening the carton is an initial step to enable stamping packs within the carton. Tax stamps are applied to packs within the carton at step 415.

Based on opening the carton, an adhesive is applied to at least one flap of the carton at step 420. Preferably, the adhesive is applied after stamping the packs. The adhesive can be a hot glue or cold glue. In another embodiment, the adhesive is applied in accord with the teachings of U.S. patent application Ser. No. ______ (atty docket 201111231/11) After the adhesive is applied, the carton is closed at a closing station at step 430. Bringing the adhesive coated flap in contact with another flap closes the carton.

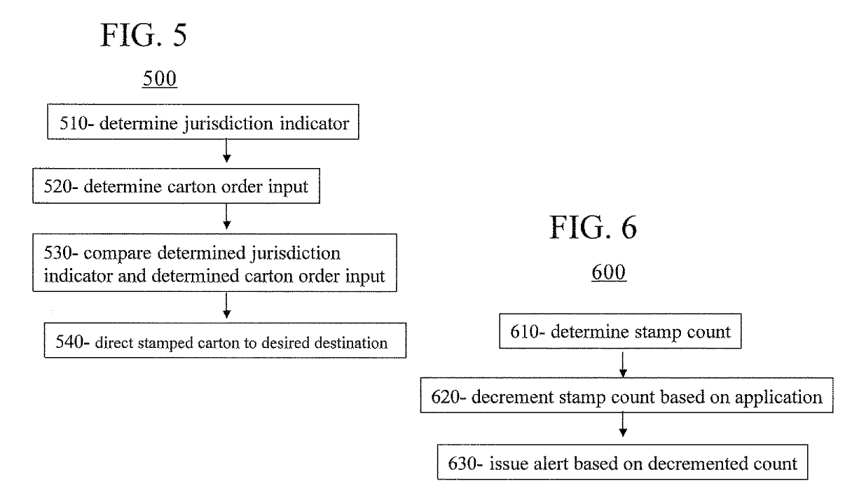

FIG. 5 illustrates a flowchart illustrative of a method 500 for applying stamps to packs within a carton. Method 500 begins by determining a jurisdiction indicator at step 510. Determining a jurisdiction indicator can include polling a data storage in the stamp cartridge for the jurisdiction indicator, or receiving the jurisdiction indicator based on a transmission from the stamp cartridge. For example, the jurisdiction indicator can be received based on establishing a network connection, or by a RFID technology.

A carton order input is determined at step 520. Determining a carton order input includes determining a desired jurisdiction or destination for the retail sale of the ordered cartons. The carton order input can be determined via a network connection, wired or wireless, or by operator input using an input device. The network connection can include an Ethernet cable, or any other network connector known to those of skill in the art.

The determined carton order input and jurisdiction indicator are compared at step 530. Based on a match, the stamped cartons are directed to desired destinations based on the applied stamp at step 540.

FIG. 6 illustrates a flowchart illustrative of a method 600 for applying stamps to packs within a carton. Method 600 begins by determining a stamp count based on the number of stamps disposed within the stamp cartridge. For example, a new cartridge includes 30,000 stamps.

The stamp count is decremented based on applying the stamps to each pack at step 620. For example, application of stamps to a carton decrements the stamp count by 10. Alternatively, the stamp count can be incremented based on stamp application. In one example, the decremented stamp count is stored on a memory device integrated with the stamp cartridge. In another example, the decremented stamp count is stored on a memory device not integrated with the stamp cartridge, but in communication with the stamping apparatus, and the decremented stamp count is associated with a unique identifier associated with the stamp cartridge. For example, a stamp cartridge can include a serial number or similar unique identifier.

An alert is issued based on the decremented stamp count at step 630. The alert can be issued, for example, if the cartridge does not have enough stamps left to stamp another carton, and a new cartridge is needed. The alert can also issue with advance warning. For example, the alert can issue when enough stamps are left for n number of cartons, such as 30 cartons. These alerts can be beneficial in high changeover environments, wherein a stamp cartridge is not run until empty.

It is important to note that the figures and description illustrate specific applications and embodiments of the present invention, and is not intended to limit the scope of the present disclosure or claims to that which is presented therein. Upon reading the specification and reviewing the drawings hereof, it will become immediately obvious to those skilled in the art that myriad other embodiments of the present invention are possible, and that such embodiments are contemplated and fall within the scope of the presently claimed invention.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A system for applying a stamp to packs within a carton, the system comprising:
a conveyor system;
a stamping system positioned along the conveyor system, the stamping system including a stamp cartridge and a stamp applicator positioned adjacent the stamp cartridge, wherein the cartridge dispenses stamps and the applicator applies the dispensed stamps to the packs.

2. The system of claim 1 further comprising:
a cartridge confirmation system including a sensing device positioned to receive a jurisdiction indicator positioned on the cartridge and a controller to confirm whether the indicator matches a carton order input.

3. The system of claim 1 further comprising:
a sensing device configured to sense a location of each stamp; and
a positioning controller configured to advance the stamp to a predetermined position.

4. The system of claim 3 wherein the sensing device includes a light receptor.

5. The system of claim 3 wherein the positioning controller includes a roller configured to translate the stamps.

6. The system of claim 1 wherein the stamp applicator includes a hot iron configured to apply hot stamped indicia to a pack.

7. The system of claim 1, wherein the stamp cartridge includes a tractor feed device.

8. The system of claim 1 further comprising a stamp counter configured to modify a count based on application of a stamp.

9. The system of claim 1 wherein the stamp cartridge includes a lid configured to translate between an open position and a closed position, and wherein the stamp cartridge includes a locking device to hold the lid in the closed position.

10. A method for applying a stamp to packs within a carton, the method comprising:
advancing at least one carton having a plurality of packs to a stamping station;
dispensing stamps from a stamp cartridge positioned at the stamping station; and
applying the dispensed stamps to the packs.

11. The method of claim 10 further comprising:
sensing an indictor positioned on the cartridge; receiving a carton order input; and comparing the order input to the indicator.

12. The method of claim 10 further comprising:
opening the carton at a carton opening station;
applying an adhesive, at an adhesive station, to at least one flap of the carton after applying the dispensed stamps to each pack; and
closing the carton at a closing station after applying the adhesive.

13. The method of claim 10 further comprising:
determining a jurisdiction indictor;
determining a carton order input;
comparing the determined jurisdiction indicator and carton order input; and
applying the dispensed stamp to each pack based on the comparison.

14. The method of claim 10 further comprising:
determining a stamp count based on the number of stamps disposed within the stamp cartridge;
decrementing the stamp count based on applying the dispensed stamps to each pack; and
issuing an alert based on the decremented stamp count.

15. A system for applying a stamp to packs within a carton, the system comprising:
means for advancing at least one carton having a plurality of packs to a stamping station;
means for dispensing stamps from a stamp cartridge positioned at the stamping station; and
means for applying the dispensed stamps to the packs.
